(19) United States
(12) Patent Application Publication
(10) Pub. No.: US 2026/0042360 A1
(43) Pub. Date: Feb. 12, 2026

(54) PIPE BRACKET FOR VEHICLE BATTERY ASSEMBLY

(71) Applicant: GM Global Technology Operations LLC, Detroit, MI (US)

(72) Inventors: Jack G. Michalski, Ferndale, MI (US); Adam Sieferman, Troy, MI (US)

(21) Appl. No.: 18/796,597

(22) Filed: Aug. 7, 2024

(51) Int. Cl. B60L 50/64; H01M 50/249

(52) U.S. Cl. CPC B60L 50/64; H01M 50/249

(57) ABSTRACT

A pipe bracket for a battery assembly of a vehicle defining a first axis, a second axis perpendicular to the first axis, and a third axis perpendicular to the first axis and the second axis includes a pipe securing structure including a pipe enclosure defining a pipe aperture configured to have a pipe pass therethrough along the first axis to secure the pipe within the pipe enclosure, and a bracket base configured to be attached to a component of a battery assembly. The bracket base includes a fragile structure that is weaker than portions of the bracket base adjacent thereto and that is configured to bend or break when a force in a direction along the second axis is received by the pipe securing structure.

### INTRODUCTION

The subject disclosure relates to the art of rechargeable energy storage systems and, more particularly, to a pipe bracket for a vehicle battery.

Rechargeable energy storage systems may include pipes for moving fluids, e.g., coolant. It may be desirable to prevent the pipes from being damaged and leaking.

### SUMMARY

In one exemplary embodiment, a pipe bracket for a battery assembly of a vehicle defining a first axis, a second axis perpendicular to the first axis, and a third axis perpendicular to the first axis and the second axis comprises a pipe securing structure comprising a pipe enclosure defining a pipe aperture configured to have a pipe pass therethrough along the first axis to secure the pipe within the pipe enclosure, and a bracket base configured to be attached to a component of a battery assembly. The bracket base comprises a fragile structure that is weaker than portions of the bracket base adjacent thereto and that is configured to bend or break when a force in a direction along the second axis is received by the pipe securing structure.

In addition to one or more of the features described herein, the pipe is a first pipe, the pipe enclosure is a first pipe enclosure, and the pipe aperture is a first pipe aperture, and the pipe securing structure further comprises a second pipe enclosure disposed above the first pipe enclosure along the third axis and defining a second pipe aperture configured to have a second pipe pass therethrough along the first axis to secure the second pipe within the second pipe enclosure.

In addition to one or more of the features described herein, the first pipe enclosure is offset from the second pipe enclosure along the second axis such that the first pipe enclosure extends farther in a direction away from the bracket base along the second axis than the second pipe enclosure.

In addition to one or more of the features described herein, the pipe bracket further comprises an arm extending upwards from the bracket base along the third axis, and an upper body extending from the arm to the pipe securing structure.

In addition to one or more of the features described herein, the upper body comprises an abutment surface facing a direction along the second axis away from the pipe securing structure.

In addition to one or more of the features described herein, the arm curves from the bracket base towards the pipe securing structure along the second axis.

In addition to one or more of the features described herein, an inner space is defined between the bracket base, the pipe securing structure, the arm, and the upper body.

In addition to one or more of the features described herein, a rib is formed on a side of the arm facing the pipe securing structure.

In addition to one or more of the features described herein, the pipe securing bracket is formed of a material that is softer and more elastic than the pipe.

In addition to one or more of the features described herein, the pipe securing bracket is formed of plastic and the pipe is formed of steel.

In yet another exemplary embodiment, a battery assembly for a vehicle defining a first axis, a second axis perpendicular to the first axis, and a third axis perpendicular to the first axis and the second axis comprises a casing assembly comprising a base and a wall extending upward from the base along the third axis, a battery cell assembly and a support structure assembly disposed on the base, a crash basin defined between the wall and the battery cell assembly or the support structure assembly, a first pipe and a second pipe for coolant, each extending at least partially within the crash basin, and a pipe securing bracket. The pipe securing bracket comprises a pipe securing structure comprising a first pipe enclosure defining a first pipe aperture configured to have the first pipe pass therethrough along the first axis to secure the first pipe within the first pipe enclosure, and a second pipe enclosure disposed above the first pipe enclosure along the third axis and defining a second pipe aperture configured to have a second pipe pass therethrough along the first axis to secure the second pipe within the second pipe enclosure, and a bracket base attached to a component of the support structure assembly. The bracket base comprises a fragile structure that is weaker than portions of the bracket base adjacent thereto and that is configured to bend or break when a force in a direction along the second axis is received by the pipe securing structure.

In addition to one or more of the features described herein, the first pipe enclosure is offset from the second pipe enclosure along the second axis such that the first pipe enclosure extends farther in a direction away from the bracket base along the second axis than the second pipe enclosure.

In addition to one or more of the features described herein, the first pipe is connected to a first pipe extension that extends downward along the third axis from the first pipe, and the second pipe is connected to a second pipe extension that extends downward along the third axis from the second pipe.

In addition to one or more of the features described herein, the pipe securing structure comprises an arm extending upwards from the bracket base along the third axis, and an upper body extending from the arm to the pipe securing structure.

In addition to one or more of the features described herein, the arm curves from the bracket base towards the pipe securing structure along the second axis.

In addition to one or more of the features described herein, an inner space is defined between the bracket base, the pipe securing structure, the arm, and the upper body.

In addition to one or more of the features described herein, a rib is formed on a side of the arm facing the pipe securing structure.

In addition to one or more of the features described herein, the pipe securing bracket is formed of a material that is softer and more elastic than the first pipe and the second pipe.

In addition to one or more of the features described herein, the pipe securing bracket is formed of plastic and the first pipe and the second pipe are formed of steel.

In yet another exemplary embodiment, a vehicle defining a first axis, a second axis perpendicular to the first axis, and a third axis perpendicular to the first axis and the second axis comprises a battery assembly, comprising a casing assembly comprising a base and a wall extending upward from the base along the third axis, a battery cell assembly and a support structure assembly disposed on the base, a crash basin defined between the wall and the battery cell assembly or the support structure assembly, a first pipe and a second pipe for coolant, each extending at least partially within the crash basin, and a pipe securing bracket. The pipe securing bracket comprises a pipe securing structure comprising a first pipe enclosure defining a first pipe aperture configured to have the first pipe pass therethrough along the first axis to secure the first pipe within the first pipe enclosure, and a second pipe enclosure disposed above the first pipe enclosure along the third axis and defining a second pipe aperture configured to have a second pipe pass therethrough along the first axis to secure the second pipe within the second pipe enclosure, and a bracket base attached to a component of the support structure assembly. The bracket base comprises a fragile structure that is weaker than portions of the bracket base adjacent thereto and that is configured to bend or break when a force in a direction along the second axis is received by the pipe securing structure.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a left side view of a vehicle including a battery assembly according to a non-limiting example;

FIG. 2A is a front perspective view of a battery assembly according to one or more embodiments;

FIG. 2B is a front perspective view of the battery assembly of FIG. 2A with top and side walls removed;

FIG. 2C is a front perspective view of a right portion of the battery assembly of FIG. 2B;

FIG. 3A is a top perspective view of a first pipe bracket according to one or more embodiments;

FIG. 3B is a bottom perspective view of the first pipe bracket of FIG. 3A;

FIG. 3C is a front view of the first pipe bracket of FIG. 3A;

FIG. 3D is a top view of the first pipe bracket of FIG. 3A;

FIG. 4 is a front perspective view of a first pipe bracket installed on a battery assembly according to one or more embodiments;

FIGS. 5A-5B are front views of the first pipe bracket before and after a lateral force is applied according to one or more embodiments;

FIG. 6A is a top perspective view of a second pipe bracket according to one or more embodiments;

FIG. 6B is a bottom perspective view of the second pipe bracket of FIG. 6A;

FIG. 6C is a front view of the second pipe bracket of FIG. 6A;

FIG. 6D is a top view of the second pipe bracket of FIG. 6A;

FIG. 7 is a front perspective view of a second pipe bracket installed on a battery assembly according to one or more embodiments; and

FIGS. 8A-8B are front views of the second pipe bracket before and after a lateral force is applied according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

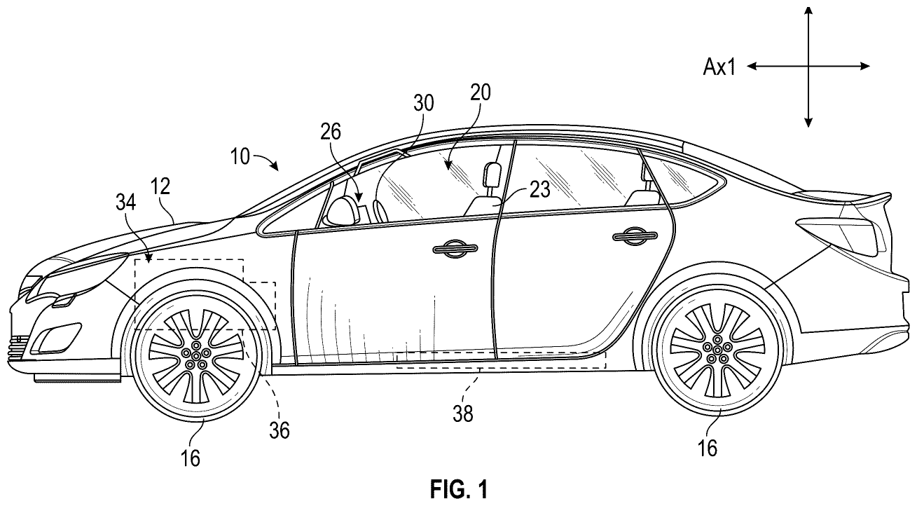

A vehicle 10 according to a non-limiting example is shown in FIG. 1. The vehicle 10 defines a first axis Ax1, a second axis Ax2 perpendicular to the first axis Ax1, and a third axis Ax3 perpendicular to the first axis Ax1 and the second axis Ax2. According to a non-limiting example, the first axis Ax1 corresponds to a longitudinal axis of the vehicle 10, the second axis Ax2 corresponds to a lateral axis of the vehicle 10, and the third axis Ax3 corresponds to a vertical axis of the vehicle. The vehicle 10 includes a body 12 supported on a plurality of wheels 16. One or more of the plurality of wheels 16 are steerable. The body 12 defines, in part, a passenger compartment 20 having seats 23 positioned behind a dashboard 26. A steering control 30 is arranged between seats 23 and a dashboard 26. The steering control 30 is operated to control orientation of the steerable wheel(s) 16.

The vehicle 10 includes an electric motor 34 connected to a gear assembly and/or transmission 36 that provides power to one or more of the plurality of wheels 16. A rechargeable energy storage system (RESS) may be arranged in the body 12 and may provide power to components within the vehicle (e.g., the electric motor 34). As a non-limiting example, the rechargeable energy storage system may include a battery assembly 38. While specific locations are shown for the electric motor 34, the gear assembly and/or transmission 36, and the battery assembly 38 in FIG. 1, these locations are merely exemplary and not limiting, and locations of these structures may vary.

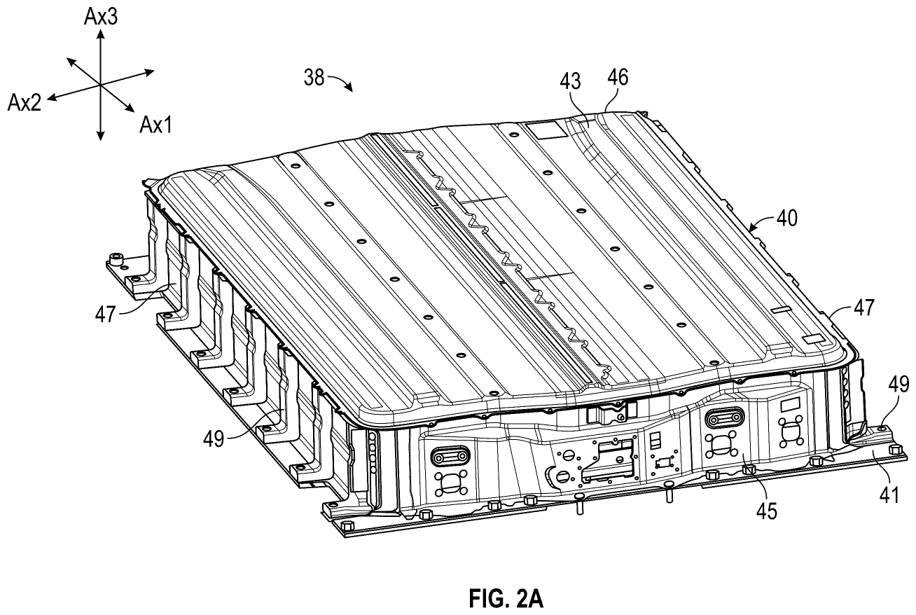

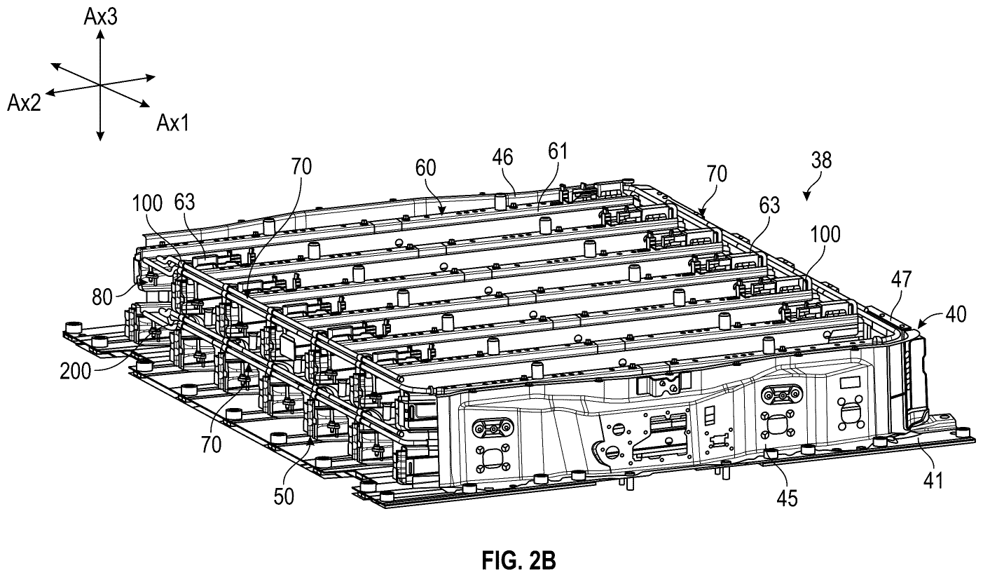

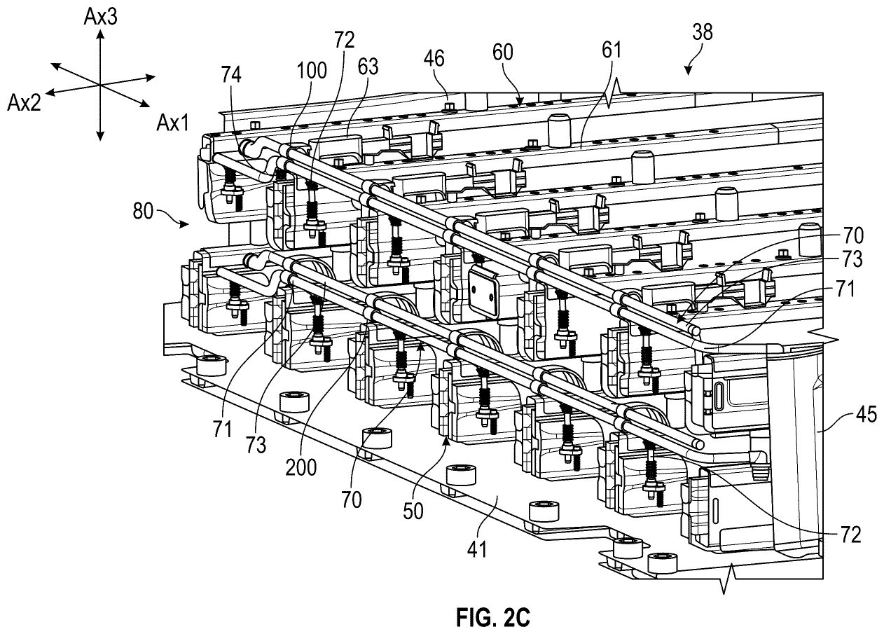

FIG. 2A shows a battery assembly 38 according to one or more embodiments. The battery assembly 38 includes a casing assembly 40 that may include a base 41, an upper wall 43, a front wall 45, a rear wall 46, and a pair of side walls 47. A plurality of casing bracket 49 may secure the side walls 47 and/or the upper wall 43 to the base 41.

As shown in FIGS. 2B and 2C, in which the upper wall 43 and one of the side walls 47 are removed, the battery assembly 38 includes a battery cell assembly 50 disposed on the base 41 within the casing assembly 40. The battery cell assembly 50 may include a plurality of battery cells that supply power to the components within the vehicle (e.g., the electric motor 34 shown in FIG. 1). The battery assembly 38 may further include a support structure assembly 60 that may, for example, support and/or secure the battery cell assembly 50 and other structural components (e.g., components of a cooling system) within the casing assembly 40 and/or support and/or secure the upper wall 43, the front wall 45, the rear wall 46, and/or the side walls 47 to the base 41. The support structure assembly 60 may include a plurality of cross beams 61 extending between the side walls 47. A plurality of upper wall support structures 63 may be disposed on the cross beams 61 to support the upper wall 43. The upper wall support structures 63 may be, for example, a Z-blocker, which is a structure that protects the battery cell assembly 50 if the upper wall 43 is pushed down during a crash. The support structure assembly 60 may include bus bars (not shown). The battery assembly 38 may define a crash basin 80 between each of the side walls 47 and an outermost portion of the battery cell assembly 50 and/or the support structure assembly 60.

A cooling system may include a coolant pipe assembly 70. Coolant may flow through the coolant pipe assembly 70 into the battery cell assembly 50 and/or the support structure assembly 60 to remove heat therefrom. Coolant heated by the battery cell assembly 50 and/or the support structure assembly 60 may flow through the coolant pipe assembly 70 to a heat removal system (not shown) which removes the heat from the coolant and returns the coolant to the coolant pipe assembly 70. The coolant pipe assembly 70 may include a plurality of first pipes 71 and a plurality of second pipes 73, each of which extends at least partially along the first axis Ax1. Each of the first pipes 71 and/or the second pipes 73 may be disposed at least partially within the crash basin 80. The first pipes 71 may be connected to the battery cell assembly 50 via first pipe extensions 72, and the second pipes 73 may be connected to the battery cell assembly 50 via second pipe extensions 74. As a non-limiting example, the first pipe 71 and the second pipe 73 may be steel pipes. The cooling system may further include a cold plate (not shown) disposed, for example, on the base 41. The first and second pipe extensions 72, 74 may connect the first pipe 71 and the second pipe 73 to a flow path in contact with the cold plate.

A plurality of first pipe brackets 100 and/or a plurality of second pipe brackets 200 may secure the first pipes 71 and/or the second pipes 73 to the support structure assembly 60. As a non-limiting example, the first pipes 71 and the second pipes 73 may pass through the first pipe brackets 100 and/or the second pipe brackets 200, and the first pipe brackets 100 and/or the second pipe brackets 200 may be fastened to a component of the support structure assembly 60 (e.g., the cross beams 61).

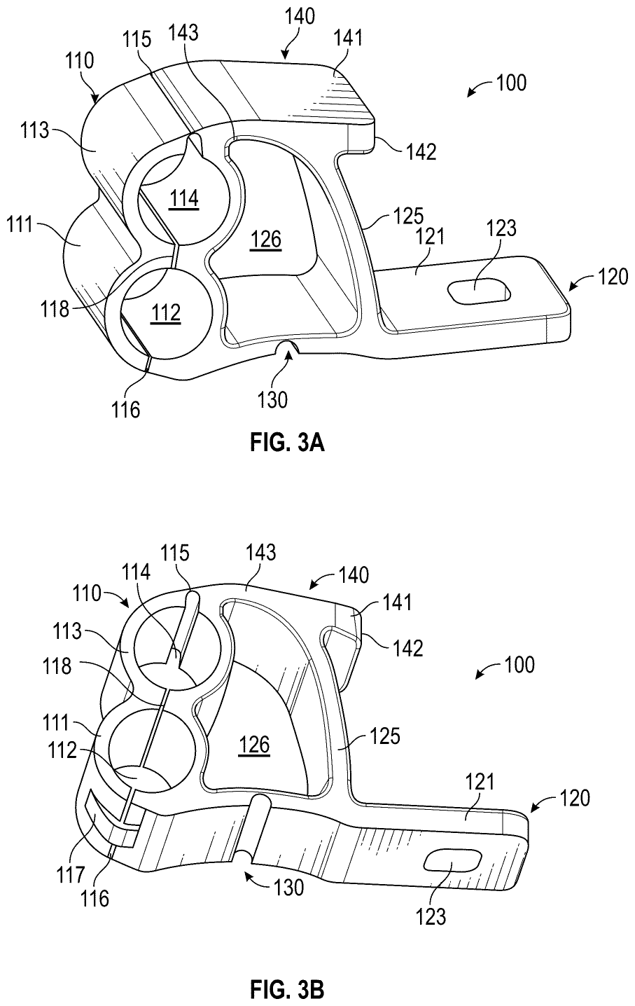

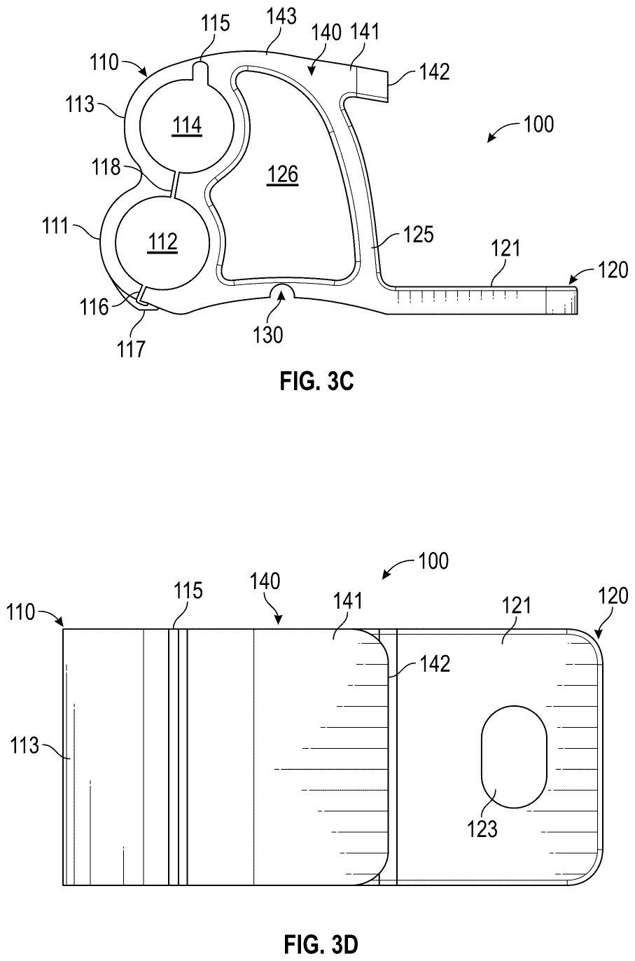

FIGS. 3A-3D show a first pipe bracket 100 according to one or more embodiments. The first pipe bracket 100 may be formed of a material that is softer and/or more elastic than the first pipe 71 and/or the second pipe 73. As a non-limiting example, the first pipe bracket 100 may be formed of injection molded plastic. The first pipe bracket 100 may be formed as a single integral structure. The first pipe bracket 100 includes a pipe securing structure 110 extending between a lower structure 120 and an upper structure 140. An arm 125 may extend between the lower structure 120 and the upper structure 140, with an inner space 126 delimited by the pipe securing structure 110, the lower structure 120, the upper structure 140, and the arm 125.

The pipe securing structure 110 may include a lower pipe enclosure 111 defining a lower pipe aperture 112 therethrough and an upper pipe enclosure 113 defining an upper pipe aperture 114 therethrough. As shown in FIG. 2C, the first pipe 71 may pass through the lower pipe aperture 112 and the second pipe 73 may pass through the upper pipe aperture 114 to secure the first pipe 71 and the second pipe 73 within the pipe securing structure 110.

The pipe securing structure 110 may further include a hinge 115, an outer opening 116, and an inner opening 118. The hinge 115 may be a living hinge. The pipe securing structure 110 may be opened about the hinge 115 to open the outer opening 116 and the inner opening 118 sufficiently wide for the second pipe 73 to pass through, and the second pipe 73 may be inserted into the upper pipe aperture 114 through the outer opening 116 and the inner opening 118. The first pipe 71 may then be inserted into the lower pipe aperture 112. The pipe securing structure 110 may then be closed. The pipe securing structure 110 may further include a latch 117 disposed to bridge the outer opening 116. Once the first pipe 71 and the second pipe 73 are secured within the pipe securing structure 110, the latch 117 may be closed.

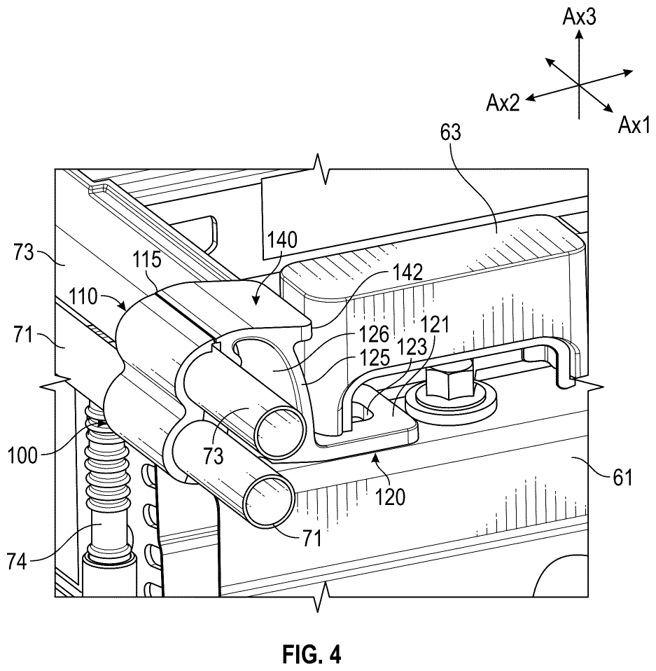

The lower structure 120 may include a bracket base 121. The bracket base 121 may have a fastener aperture 123 extending therethrough. The bracket base 121 may be attached to a component of the battery cell assembly 50 or a component of the support structure assembly 60. As a non-limiting example, as shown in FIG. 4, the bracket base 121 may be attached to one of the cross beams 61 via a fastener through the fastener aperture 123. The fastener may be, for example, a screw, a pin, an adhesive, or other fasteners known in the art. Alternatively, the bracket base 121 may be attached to one of the cross beams 61 or another component of the battery cell assembly 50 or the support structure assembly 60 via other attachment structures known in the art. A fragile structure 130 may be disposed on the bracket base 121. As a non-limiting example, the fragile structure 130 may be formed at a position on the bracket base 121 under the inner space 126. The fragile structure 130 may be a thinned portion of the bracket base 121 having a thickness less than portions of the bracket base 121 adjacent to the fragile structure. While FIGS. 3A-3C show the fragile structure 130 formed with a curved cutout at a bottom surface of the bracket base 121, the present application is not limited thereto.

The arm 125 extends upward from the bracket base 121 towards the upper structure 140. The arm 125 may curve towards the pipe securing structure 110 from the bracket base 121 towards the upper structure 140.

The upper structure 140 may include an upper body 141 that extends between the arm 125 and the pipe securing structure 110 with a neck portion 143 connecting the upper body 141 to the pipe securing structure 110. The upper body 141 may further extend beyond the arm 125 in a direction away from the pipe securing structure 110, terminating at an abutment surface 142. As shown in FIG. 4, the abutment surface 142 may face a component of the battery cell assembly 50 or a component of the support structure assembly 60. As a non-limiting example, as shown in FIG. 4, the abutment surface 142 may face one of the upper wall support structures 63. According to one or more embodiments, the abutment surface 142 may face a bus bar.

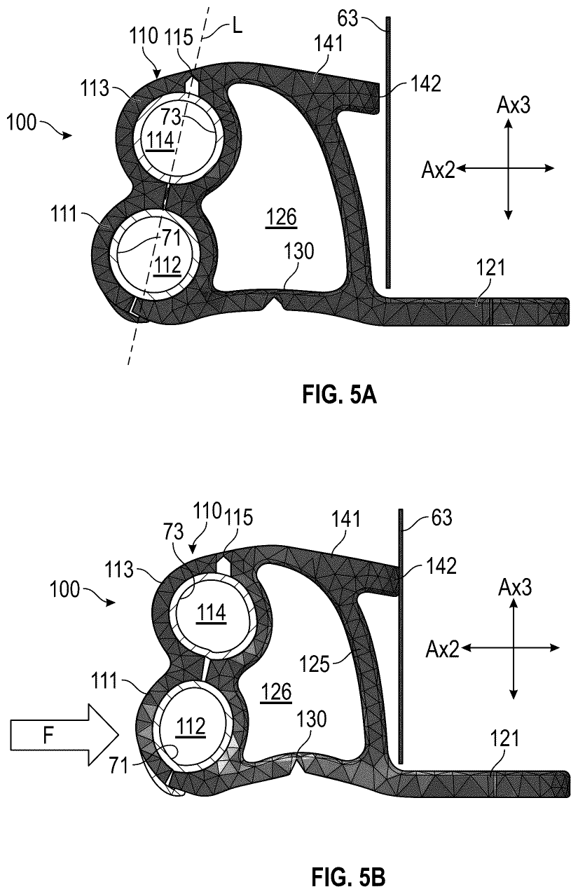

As described above, at least a portion of the first pipe 71 and/or the second pipe may be within the crash basin 80 of the battery assembly 38 defined between the side wall 47 and the outermost portion of the battery cell assembly 50 and/or the support structure assembly 60. The crash basin 80 may provide a buffer such that, during a crash, the crash basin 80 mitigates damage to the battery cell assembly 50. Because the first pipe 71 and the second pipe 73 may extend at least partially within the crash basin 80, during a crash, a crash force F may act on the first pipe 71, the second pipe 73, and/or the first pipe bracket 100. As shown in FIG. 5B, by forming the first pipe bracket 100 of a softer and/or or more elastic material than the first pipe 71, the first pipe bracket 100 may deform or break without shearing the first pipe 71 or the second pipe 73.

FIGS. 5A-5B illustrate the first pipe bracket 100 receiving a crash force F. As shown in FIG. 5A, the lower pipe enclosure 111 may extend farther outward than the upper pipe enclosure 113 along the second axis Ax2 such that the lower pipe enclosure 111 is offset from the upper pipe enclosure 113. A line L drawn through centers of the lower pipe enclosure 111 and the upper pipe enclosure 113 in a plane perpendicular to the second axis Ax2 forms an angle with the third axis Ax3. The bracket base 121 may be anchored to a component of the support structure assembly 60 (e.g., one of the cross beams 61). Thus, the crash force F is received by the lower pipe enclosure 111 prior to the upper pipe enclosure 113. As the crash force F pushes the lower pipe enclosure 111 inwards along the second axis Ax2, as shown in FIG. 5B, the inner space 126 provides space for the pipe securing structure 110 and the first pipe 71 and the second pipe 73 therein to move inwards with minimal resistance. Furthermore, as the fragile structure 130 may be weaker than the remainder of the bracket base 121, the fragile structure 130 may fold and/or break from the force F, resulting in the pipe securing structure 110 and the first pipe 71 and the second pipe 73 therein moving downwards along the third axis Ax3 while moving inwards along the second axis Ax2. Further, as described above and as shown in FIG. 5A, the abutment surface 142 may face a component of the battery cell assembly 50 or a component of the support structure assembly 60. As a non-limiting example, the abutment surface 142 may face the upper wall support structure 63 as shown in FIG. 5A. As the crash force F pushes the pipe securing structure 110 inwards along the second axis Ax2, the abutment surface 142 may abut against the upper wall support structure 63 such that upper wall support structure 63 pushes back against (i.e., resists crash force F) the pipe securing structure 110 and the first pipe 71 and the second pipe 73 therein, further aiding in the downward movement of the pipe securing structure 110 and the first pipe 71 and the second pipe 73 therein.

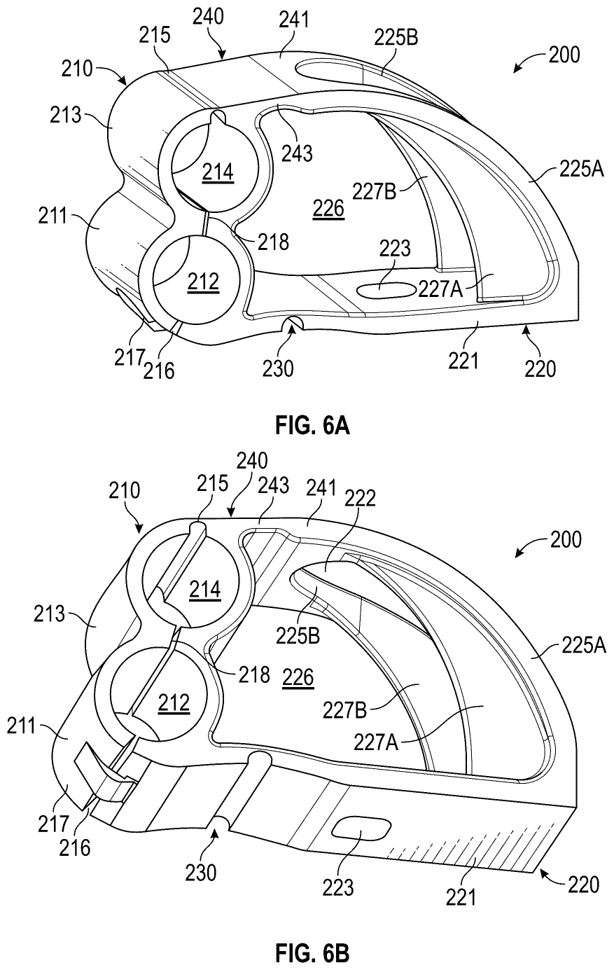

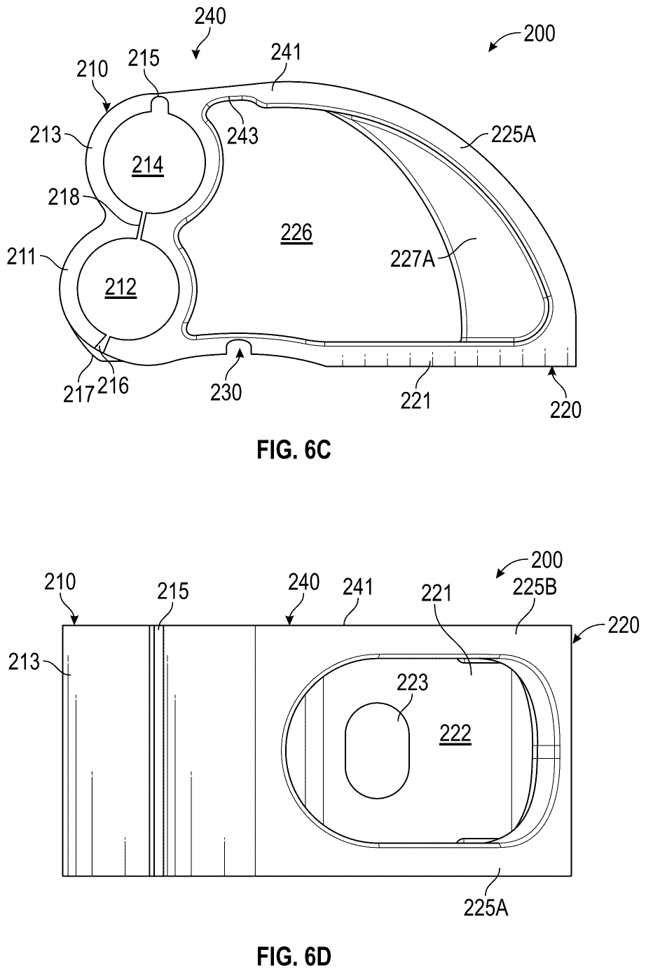

FIGS. 6A-6D show a second pipe bracket 200 according to one or more embodiments. The second pipe bracket 200 may be formed of a material that is softer and/or more elastic than the first pipe 71 and/or the second pipe 73. As a non-limiting example, the second pipe bracket 200 may be formed of injection molded plastic. The second pipe bracket 200 may be formed as a single integral structure. The second pipe bracket 200 includes a pipe securing structure 210 extending between a lower structure 220 and an upper structure 240. A first arm 225A and a second arm 225B may extend between the lower structure 220 and the upper structure 240, with an inner space 226 delimited by the pipe securing structure 210, the lower structure 220, the upper structure 240, and the first and second arms 225A, 225B. Furthermore, a first rib 227A may extend from the first arm 225A and the second rib 227B may extend from the second arm 225B.

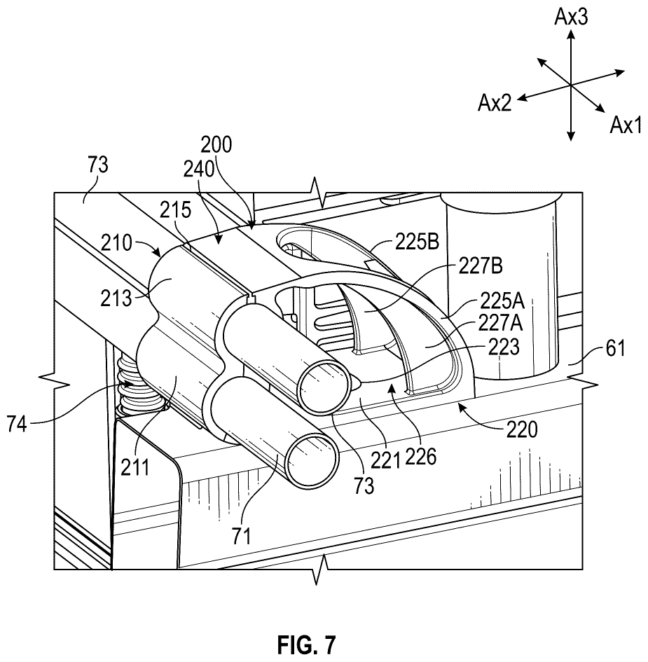

The pipe securing structure 210 may include a lower pipe enclosure 211 defining a lower pipe aperture 212 extending therethrough and an upper pipe enclosure 213 defining an upper pipe aperture 214 extending therethrough. As shown in FIG. 7, the first pipe 71 may pass through the lower pipe aperture 212 and the second pipe 73 may pass through the upper pipe aperture 214 to secure the first pipe 71 and the second pipe 73 within the pipe securing structure 210.

The pipe securing structure 210 may further include a hinge 215, an outer opening 216, and an inner opening 218. The hinge 215 may be a living hinge. The pipe securing structure 210 may be opened about the hinge 215 to open the outer opening 216 and the inner opening 218 sufficiently wide for the second pipe 73 to pass through, and the second pipe 73 may be inserted into the upper pipe aperture 214 through the outer opening 216 and the inner opening 218. The first pipe 71 may then be inserted into the lower pipe aperture 212. The pipe securing structure 210 may then be closed. The pipe securing structure 210 may further include a latch 217 disposed to bridge the outer opening 216. Once the first pipe 71 and the second pipe 73 are secured within the pipe securing structure 210, the latch 217 may be closed.

The lower structure 220 may include a bracket base 221. The bracket base 221 may have a fastener aperture 223 formed therethrough. The bracket base 221 may be attached to a component of the battery cell assembly 50 or a component of the support structure assembly 60. As a non-limiting example, as shown in FIG. 7, the bracket base 221 may be attached to one of the cross beams 61 via a fastener through the fastener aperture 223. The fastener may be, for example, a screw, a pin, an adhesive, or other fasteners known in the art. Alternatively, the bracket base 221 may be attached to one of the cross beams 61 or another component of the battery cell assembly 50 or the support structure assembly 60 via other attachment structures known in the art. A fragile structure 230 may be disposed on the bracket base 121. As a non-limiting example, the fragile structure 230 may be formed at a position on the bracket base 221 under the inner space 226. The fragile structure 230 may be a thinned portion of the bracket base 221 having a thickness less than portions of the bracket base 221 adjacent to the fragile structure. While FIGS. 6A-6C show the fragile structure 230 formed with a curved cutout at a bottom surface of the bracket base 221, the present application is not limited thereto.

The first arm 225A and the second arm 225B extend upward from the bracket base 221 towards the upper structure 240. The first arm 225A and the second arm 225B may curve towards the pipe securing structure 210 from the bracket base 221 towards the upper structure 240. The first and second ribs 227A, 227b extending from the first and second arms 225A, 225B may provide added stiffness and strength to the first and second arms 225A, 225B.

The upper structure 240 may include an upper body 241 that extends between the first and second arms 225A, 225B and the pipe securing structure 210 with a neck portion 243 connecting the upper body 241 to the pipe securing structure 110.

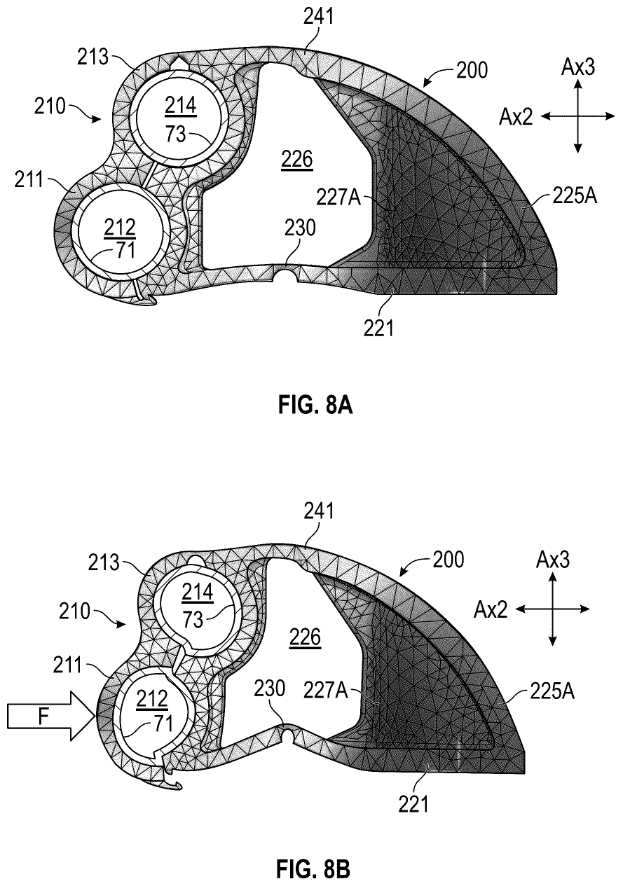

As described above, at least a portion of the first pipe 71 and/or the second pipe may be within the crash basin 80 of the battery assembly 38 defined between the side wall 47 and the outermost portion of the battery cell assembly 50 and/or the support structure assembly 60. The crash basin 80 may provide a buffer such that, during a crash, the crash basin 80 mitigates damage to the battery cell assembly 50. Because the first pipe 71 and the second pipe 73 may extend at least partially within the crash basin 80, during a crash, as shown in FIG. 8B, a crash force F may act on the first pipe 71, the second pipe 73, and/or the second pipe bracket 200. If the crash force Facts on the first pipe 71 and/or the second pipe 73, by forming the second pipe bracket 200 of a softer and/or or more elastic material than the first pipe 71, the second pipe bracket 200 may deform or break without shearing the first pipe 71 or the second pipe 73.

FIGS. 8A-8B illustrate the second pipe bracket 200 receiving a crash force F. As shown in FIG. 8A, the lower pipe enclosure 211 may extend farther outward than the upper pipe enclosure 213 along the second axis Ax2. The bracket base 221 may be anchored to a component of the support structure assembly 60 (e.g., one of the cross beams 61). Thus, the crash force F is received by the lower pipe enclosure 211 prior to the upper pipe enclosure 213. As the crash force F pushes the lower pipe enclosure 211 inwards along the second axis Ax2, the inner space 226 provides space for the pipe securing structure 210 and the first pipe 71 and the second pipe 73 therein to move inwards with minimal resistance. Furthermore, as the fragile structure 230 may be weaker than the remainder of the bracket base 221, the fragile structure 230 may fold and/or break from the force F, resulting in the pipe securing structure 210 and the first pipe 71 and the second pipe 73 therein moving downwards along the third axis Ax3 while moving inwards along the second axis Ax2.

If the first pipe 71 and/or the second pipe 73 were to move in an upward direction along the third axis Ax3 during a crash, the first pipe 71 and/or the second pipe 73 may pull on the first pipe extension 72 and the second pipe extension 74 that extend downward from the first pipe 71 and the second pipe 73 as shown in FIG. 7, generating stresses therein. Any breaks in the first pipe extension 72 and/or the second pipe extension 74 due to such stresses may result in coolant leakage. To prevent the stresses on the first pipe extension 72 and the second pipe extension 74, the first pipe bracket 100 and the second pipe bracket 200 are structured to passively guide the first pipe 71 and the second pipe 73 in a downward direction along the third axis Ax3 when a crash force F is received by the first pipe bracket 100 and the second pipe bracket 200. Furthermore, the first pipe bracket 100 includes an abutment surface 142 that leverages existing an existing component of the battery cell assembly 50 or the support structure assembly 60 to aid in guiding the first pipe 71 and/or the second pipe 73 downwards. Additionally, the first pipe bracket 100 and/or the second pipe bracket 200 may be formed of a material that is softer and more elastic than the first pipe 71 and/or the second pipe 73 such that, if the crash force F is received by the first pipe 71 and/or the second pipe 73, the first pipe bracket 100 and/or the second pipe bracket 200 do not shear the first pipe 71 and/or the second pipe 73 so that the first pipe 71 and/or the second pipe 73 do not break and leak coolant. Thus, leakage from the first pipe 71, the second pipe 73, the first pipe extension 72, and the second pipe extension 74 may be prevented during a crash.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A pipe bracket for a battery assembly of a vehicle defining a first axis, a second axis perpendicular to the first axis, and a third axis perpendicular to the first axis and the second axis, the pipe bracket comprising:
a pipe securing structure comprising a pipe enclosure defining a pipe aperture configured to have a pipe pass therethrough along the first axis to secure the pipe within the pipe enclosure; and
a bracket base configured to be attached to a component of a battery assembly,
wherein the bracket base comprises a fragile structure that is weaker than portions of the bracket base adjacent thereto and that is configured to bend or break when a force in a direction along the second axis is received by the pipe securing structure.

2. The pipe bracket of claim 1,
wherein the pipe is a first pipe, the pipe enclosure is a first pipe enclosure, and the pipe aperture is a first pipe aperture, and
wherein the pipe securing structure further comprises a second pipe enclosure disposed above the first pipe enclosure along the third axis and defining a second pipe aperture configured to have a second pipe pass therethrough along the first axis to secure the second pipe within the second pipe enclosure.

3. The battery assembly of claim 2, wherein the first pipe enclosure is offset from the second pipe enclosure along the second axis such that the first pipe enclosure extends farther in a direction away from the bracket base along the second axis than the second pipe enclosure.

4. The pipe bracket of claim 1, further comprising:
an arm extending upwards from the bracket base along the third axis, and
an upper body extending from the arm to the pipe securing structure.

5. The pipe bracket of claim 4, wherein the upper body comprises an abutment surface facing a direction along the second axis away from the pipe securing structure.

6. The pipe bracket of claim 4, wherein the arm curves from the bracket base towards the pipe securing structure along the second axis.

7. The pipe bracket of claim 4, wherein an inner space is defined between the bracket base, the pipe securing structure, the arm, and the upper body.

8. The pipe bracket of claim 4, wherein a rib is formed on a side of the arm facing the pipe securing structure.

9. The pipe bracket of claim 1, wherein the pipe securing bracket is formed of a material that is softer and more elastic than the pipe.

10. The pipe bracket of claim 1, wherein the pipe securing bracket is formed of plastic and the pipe is formed of steel.

11. A battery assembly for a vehicle defining a first axis, a second axis perpendicular to the first axis, and a third axis perpendicular to the first axis and the second axis, the battery assembly comprising:
a casing assembly comprising a base and a wall extending upward from the base along the third axis;
a battery cell assembly and a support structure assembly disposed on the base;
a crash basin defined between the wall and the battery cell assembly or the support structure assembly;
a first pipe and a second pipe for coolant, each extending at least partially within the crash basin; and
a pipe securing bracket, comprising:
a pipe securing structure comprising a first pipe enclosure defining a first pipe aperture configured to have the first pipe pass therethrough along the first axis to secure the first pipe within the first pipe enclosure, and a second pipe enclosure disposed above the first pipe enclosure along the third axis and defining a second pipe aperture configured to have a second pipe pass therethrough along the first axis to secure the second pipe within the second pipe enclosure, and
a bracket base attached to a component of the support structure assembly,
wherein the bracket base comprises a fragile structure that is weaker than portions of the bracket base adjacent thereto and that is configured to bend or break when a force in a direction along the second axis is received by the pipe securing structure.

12. The battery assembly of claim 11, wherein the first pipe enclosure is offset from the second pipe enclosure along the second axis such that the first pipe enclosure extends farther in a direction away from the bracket base along the second axis than the second pipe enclosure.

13. The battery assembly of claim 11, wherein the first pipe is connected to a first pipe extension that extends downward along the third axis from the first pipe, and the second pipe is connected to a second pipe extension that extends downward along the third axis from the second pipe.

14. The battery assembly of claim 11, wherein the pipe securing structure comprises:
an arm extending upwards from the bracket base along the third axis, and
an upper body extending from the arm to the pipe securing structure.

15. The battery assembly of claim 14, wherein the arm curves from the bracket base towards the pipe securing structure along the second axis.

16. The battery assembly of claim 14, wherein an inner space is defined between the bracket base, the pipe securing structure, the arm, and the upper body.

17. The battery assembly of claim 14, wherein a rib is formed on a side of the arm facing the pipe securing structure.

18. The battery assembly of claim 11, wherein the pipe securing bracket is formed of a material that is softer and more elastic than the first pipe and the second pipe.

19. The battery assembly of claim 11, wherein the pipe securing bracket is formed of plastic and the first pipe and the second pipe are formed of steel.

20. A vehicle defining a first axis, a second axis perpendicular to the first axis, and a third axis perpendicular to the first axis and the second axis, the vehicle comprising a battery assembly, comprising:
a casing assembly comprising a base and a wall extending upward from the base along the third axis;
a battery cell assembly and a support structure assembly disposed on the base;
a crash basin defined between the wall and the battery cell assembly or the support structure assembly;
a first pipe and a second pipe for coolant, each extending at least partially within the crash basin; and
a pipe securing bracket, comprising:
a pipe securing structure comprising a first pipe enclosure defining a first pipe aperture configured to have the first pipe pass therethrough along the first axis to secure the first pipe within the first pipe enclosure, and a second pipe enclosure disposed above the first pipe enclosure along the third axis and defining a second pipe aperture configured to have a second pipe pass therethrough along the first axis to secure the second pipe within the second pipe enclosure, and
a bracket base attached to a component of the support structure assembly,
wherein the bracket base comprises a fragile structure that is weaker than portions of the bracket base adjacent thereto and that is configured to bend or break when a force in a direction along the second axis is received by the pipe securing structure.
